(19) United States
(12) Patent Application Publication
(10) Pub. No.: US 2026/0326831 A1
(43) Pub. Date: Oct. 22, 2026

(54) INJECTION MOLDED AUTOMOTIVE BODY PART BASED ON A POLYARYLETHERKETONE (PAEK)

(71) Applicant: Syensqo Specialty Polymers USA, LLC, Alpharetta, GA (US)

(72) Inventors: David McIlroy, Johns Creek, GA (US); Keshav S. Gautam, Suwanee, GA (US); Mohammad Jamal El-Hibri, Atlanta, GA (US)

(73) Assignee: Syensqo Specialty Polymers USA, LLC, Alpharetta, GA (US)

(21) Appl. No.: 19/485,222

(22) PCT Filed: May 14, 2024
(86) PCT No.: PCT/EP2024/063232

§ 371 Date: Nov. 17, 2025

Related U.S. Application Data
(60) Provisional application No. 63/502,140, filed on May 15, 2023.

(30) Foreign Application Priority Data
Jul. 5, 2023 (EP) 23183644.6

(51) Int. Cl. B62D 29/04; B29C 45/00; B29K 71/00; B29K 81/00; B29K 105/00; B29K 509/00; B29L 31/30

(52) U.S. Cl. CPC B62D 29/04; B29C 45/0001; B29K 2071/00; B29K 2081/04; B29K 2081/06; B29K 2105/0005; B29K 2105/0088; B29K 2509/00; B29K 2995/0012; B29K 2995/0089; B29L 2031/3055

(57) ABSTRACT

This present invention pertains to an automotive body part comprising a polymeric part made of or comprising a polymeric blend (PB) which comprises or consists of: —between 45.0 and 65.0 wt % of at least one polyaryletherketone (PAEK); —at least one amorphous thermoplastic polymer (ATP); —the total proportion of PAEK(s) and ATP(s) being between 85.0 and 96.0 wt %; —between 1.0 and 15.0 wt % of a least one inorganic filler selected in the group consisting of talc, boron nitride, mica, graphite, graphene and combinations of two or more of said inorganic fillers; —optionally up to 14.0 wt % of at least one plastic additive, notably selected in the group consisting of colorants, impact modifiers, ultraviolet light stabilizer, heat stabilizers, antioxidants, internal lubricants and/or external lubricants, flame retardants, anti-static agents, anti-blocking agents and combinations thereof; these proportions being given in wt % relative to the total weight of the polymeric blend (PB); and which exhibits a heat of fusion (Hm) of at least 20.0 J/g.

This application claims priority of U.S. provisional application No 63/502,140 filed on 15 May 2023 and European patent application No. 23183644.6 filed on 5 Jul. 2023, the content of which being entirely incorporated herein by reference for all purposes. In case of any incoherency between the two applications that would affect the clarity of a term or expression, it should be made reference to the present application only.

### TECHNICAL FIELD

This present invention pertains to an automotive body part comprising a polymeric part made of or comprising a polymeric blend (PB) of at least one polyaryletherketone (PAEK) and at least one amorphous thermoplastic polymer (ATP) having a glass transition temperature (Tg) of at least 180° C. The invention also relates to the use of the polymeric blend (PB) for the preparation of an automotive body panel.

### BACKGROUND ART

Automotive body parts present significant challenges for vehicle manufacturers as the industry continues to try and decrease the weight of the parts of the vehicle.

While these parts must be lighter in weight, they are also subject to high safety standards that require stiff and strong materials. Modern body panels must meet crash and safety performance regulations, structural integration, UV durability and design flexibility.

Sheet molding compounds (SMC) have gained widespread use in the automotive industry as a molding compound for exterior vehicle parts, due to their ability to deliver all of the structural properties of metal, while introducing other advantages such as lower vehicle body weight, lower tooling costs and an increase in vehicle part styling freedom and its inherent corrosion resistance.

WO 2021/204718 discloses a PEDEK-PEoEK copolymer that can be used to prepare an article for automotive, for aerospace or for electronics.

U.S. Pat. No. 7,935,754 B2 discloses an automotive body panel containing a polymer composite formed of at least one polymer and a modified graphite oxide.

US 2018/072847 (D1) discloses a thermoplastic composition comprising 25 to less than 95 weight percent poly(etherimide-siloxane) copolymer having a siloxane content of more than 0 to less than 50 weight percent based on the total weight of the poly(etherimide-siloxane) copolymer and 5-75 weight percent of an aromatic polyketone. The poly(etherimide-siloxane) copolymer comprises polyetherimide units and polysiloxane units. In the examples, the proportion of siloxane is 20 wt % and 40 wt %.

CN 115746499 (D2) discloses a composite membrane where a layer of boron nitride is present on top of a polymeric blend. The particles of boron nitride are therefore not blended with the other components of the polymeric blend.

EP 2899230 (D3) discloses an automotive article comprising at least one part made of a composition comprising i) from 35 to 98 wt % of a polymeric material, comprising from 25 to 85 wt % of at least one polyetherimide polymer and from 15 to 75 wt % of at least one polyaryletherketone polymer and ii) from 2 to 65 wt % of a filler comprising from 5 to 95 wt % of at least one fibrous filler, and from 5 to 95 wt % of at least one mineral filler. The examples of D3 are based on the use of polyimide Aurum® PD 450 (chemical formula disclosed in EP1013714) or polyimide Aurum® PL 6200 of Mitsui (chemical formula disclosed in EP0978529). The formula of the polyimide is the following:

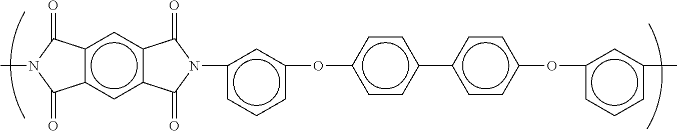

D3 does not disclose the composition of claim 1.

### Technical Problem to be Solved

Sheet molding compounds (SMC) are based on thermosetting resins which are usually unsaturated polyesters and vinyl ester resins, these constituents being typically provided in solution with styrene monomer. The preparation of automotive body panels by injection moulding is preferred because it is an easier to implement process and the emission of volatile compounds (VOC) is much lower.

Bumpers and body panels have been made of blends of thermoplastic polymers such as Xenoy® (PC+PBT). Yet, there is a need for polymeric materials having higher temperature resistance capability.

There is therefore the need for automotive body parts notably automotive body panels which can be prepared by injection moulding and which exhibit high impact performance, notably at low temperature, and excellent thermodimensional stability (this requires a low CLTE). Additionally, these parts are exposed to a wide range of environmental conditions that deteriorate the exterior surface over time. For instance, the parts should be chemically resistant notably to the substances that can come into contact with the panel (e.g. lubricants, fuels). There is therefore also the need for a chemically resistant material.

The invention aims at solving this technical problem.

### BRIEF DISCLOSURE OF THE INVENTION

The invention is set out in the appended set of claims.

Thus, the invention relates to an automotive body part as defined in any one of claims 1-34.

The invention also relates to the use of a polymeric blend (PB) as defined in any one of claims 35-39.

The invention also relates to the use of a polymer (P) as defined in claim 40.

The invention also relates to a method of preparation of the polymeric part of an automotive body part as defined in any one of claims 41-45.

These subject-matters are now defined in more details below.

### FIGURES

FIG. 1 represents various automotive body parts.

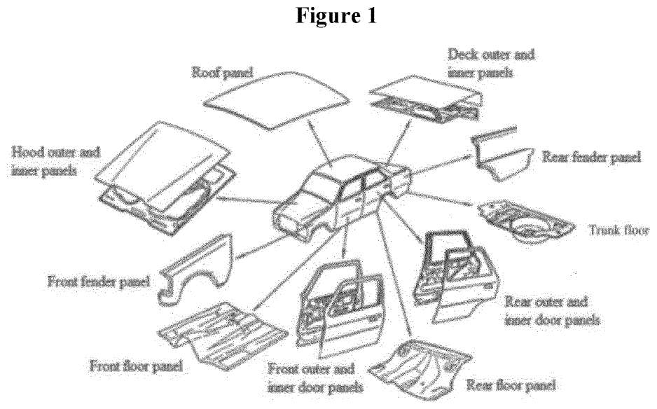

### DEFINITIONS

The melting temperature (Tₘ) is the temperature determined as the peak temperature of the melting endotherm on the 2^{nd} heat scan in differential scanning calorimeter (DSC) according to ASTM D3418-03 and using heating and cooling rates of 20° C./min. For the purpose of the present description, a polymer is crystalline if a melting endotherm is detected in the second heat scan.

The heat of fusion (Hm) of a composition denotes the heat of fusion as measured by DSC according to ASTM D3418-03 using the second heat scan. It is expressed in J/g where the weight (in g) to be taken into account is the weight of the composition.

A polymer is amorphous when the heat of fusion (Hm) is lower and equal to 5.0 J/g, preferably lower and equal to 2.0 J/g, more preferably lower than 1.0 J/g.

The glass transition temperature (Tg) is measured by DSC according to ASTM D3418-03.

wt %: % by weight. mol %: % by mole.

The proportions of recurring units in the polymers are expressed in mol % relative to the total number of recurring units in the polymer.

In all numerical ranges (also in those without upper or lower end points notably the open-ended ranges such as those comprising “at least”, “at most”, “lower than”, etc), unless otherwise indicated, the end-points are included.

In the present application, unless otherwise indicated, any specific embodiment or technical feature relating to a subject-matter is applicable to and interchangeable with another embodiment or technical feature relating to the same subject-matter or to another subject-matter and disclosed elsewhere in the application.

### DISCLOSURE OF THE INVENTION

The invention relates to an automotive body part comprising a polymeric part made of or comprising a polymeric blend (PB) as defined herein.

The automotive body part comprises a polymeric part and generally also comprises other elements such as metallic ones. For instance, the automotive body part may include at least one mean to attach the automotive body part to other parts. The automotive body part (e.g. door panel) may also include a metallic frame that imparts further mechanical rigidity to the part and on which the automotive body part may be attached. The automotive body part (e.g. door panel) may include an handle.

The polymeric part is preferably a panel which may be flat and/or curved. Pursuant to this preference, the automotive body part is a panel which may be flat and/or curved.

According to an embodiment, the polymeric part can be described as a tri-dimensional structure having a length, a width and thickness, wherein both length L and width W are significantly larger than the thickness T. According to an embodiment, L/T and W/T are greater and equal to 100, preferably greater and equal to 150.

The automotive body part may more particularly be selected in the group consisting of: roof panels, hood panels, deck panels, rear fender panels, front fender panels, quarter panels, trunk lids, rear hatch panels, floor panels and door panels.

The automotive body part may be more particularly selected in the group consisting of rear fender panels, front fender panels, doors and quarter panels.

The automotive body part may be any one of the listed body parts.

According to an embodiment, an additional layer (L) in contact with a surface of the polymeric part is present. The function of the additional layer (L) is generally to impart visual effects and/or protection of the surface underneath. The automotive body part thus comprises a surface of the polymeric blend (PB) with an additional layer (L) in contact with a surface of the polymeric part.

The additional layer (L) may itself be constituted of several layers, each having a specific function. As an example under this embodiment, the additional layer (L) may be constituted of layers (L1)/(L2), the layer (L1) being an adhesive layer and layer (L2) being a layer imparting a visual effect and/or protection.

The function of the adhesive layer (L1) is to bond layer (L2) with the surface of the polymeric blend (PB). According to an embodiment, the adhesive layer (L1) comprises a plastic adhesion promoter (or primer). The primer is generally applied on the surface and baked before applying layer (L2). According to an embodiment, the primer is a conductive primer. The use of a conductive primer makes it possible to dissipate static charges.

The function of layer (L2) is to impart a visual effect and/or protection. Layer (L2) may comprise a topcoat and a clearcoat.

According to an embodiment, a surface of the polymeric part is pretreated with a treatment selected from flame treatment, corona treatment, plasma treatment, mechanical abrasion and chemical treatment to improve the adhesion of any layer (e.g. layer (L1)) in contact with said surface.

The invention also relates to the use of a polymeric blend (PB), as defined herein and notably as defined in the claims, for the preparation of a polymeric part of an automotive body part. All details and embodiments disclosed in the present disclosure for the polymer part and/or the automotive body part apply for this invention. All details and embodiments disclosed in the present disclosure for the polymeric blend (PB) apply for this invention.

The invention also relates to a method of preparation of a polymeric part of an automotive body part comprising the step of injection moulding a polymeric blend (PB), as defined herein and notably as defined in the claims. Injection molding is a process in which the polymer blend (PB) in the molten form is injected into a mold and after cooling, the polymeric part of the automotive body part is taken out from the mold. All details and embodiments disclosed in the present disclosure for the polymer part and/or the automotive body part apply for this invention. All details and embodiments disclosed in the present disclosure for the polymeric blend (PB) apply for this invention.

The invention also relates to the use of a polymer (P) for the preparation of the polymeric part of the automotive body part as defined herein or for the preparation of an automotive body part as defined herein, polymer (P) being selected in the group of polyaryletherketones (PAEK), polyphenylsulfones (PPSU), polyethersulfones (PES), polysulfones (PSU) and polyetherimides (PEI). All details and embodiments disclosed in the present disclosure for polymer (P) apply for this invention. All details and embodiments disclosed in the present disclosure for the polymeric part or for the automotive body panel apply for this invention. Polymer (P) may be any of the polymers PAEK as disclosed herein or any of the polymers ATP as disclosed herein. Polymer (P) may notably be a PEEK as defined herein.

### Polymeric Blend (PB)

The polymeric blend (PB) is as described in the set of claims. More details are now provided.

The polymeric blend (PB) comprises or consists of:
between 45.0 and 65.0 wt % of at least one polyaryletherketone (PAEK);
at least one amorphous thermoplastic polymer (ATP) (i) having a glass transition temperature Tg of at least 180° C. and (ii) selected in the group consisting of polyphenylsulfone (PPSU), polyethersulfone (PES), polysulfone (PSU), polyetherimide (PEI) and combinations of two or more of said polymers;
the total proportion of PAEK(s) and ATP(s) being between 85.0 and 96.0 wt %;
between 1.0 and 15.0 wt % of a least one inorganic filler selected in the group consisting of talc, boron nitride, mica, graphite, graphene and combination of two or more of said inorganic fillers;
optionally up to 14.0 wt % of at least one plastic additive, notably selected in the group consisting of colorants (e.g. dyes and/or pigments), impact modifiers, ultraviolet light stabilizer, heat stabilizers, antioxidants, internal lubricants and/or external lubricants, flame retardants, anti-static agents, anti-blocking agents and combinations thereof; and exhibits a heat of fusion (Hₘ) of at least 20.0 J/g.

The proportions of the components of the polymeric blend (PB) are given in wt % relative to the total weight of the polymeric blend (PB).

The ATP is more particularly selected in the group consisting of PPSU and combinations of PPSU and PES.

The polymeric blend (PB) may comprise one PAEK or more than one PAEK.

The polymeric blend (PB) may comprise one ATP or more than one ATP.

The proportion of PAEK(s) is between 45.0 wt % and 65.0 wt %. This proportion may preferably be between 45.0 wt % and 60.0 wt % or between 45.0 wt % and 57.0 wt %.

The proportion of inorganic filler(s) is between 1.0 wt % and 15.0 wt %. This proportion is preferably between 4.0 wt % and 15.0 wt %, preferably between 4.0 wt % and 12.0 wt %, preferably between 4.0 wt % and 10.0 wt % or between 6.0 wt % and 10.0 wt %.

The total proportion of PAEK(s) and ATP(s) is between 85.0 wt % and 96.0 wt %. This proportion is preferably at least 88.0 wt %, preferably at least 90.0 wt %.

According to a preferred embodiment (E), the polymeric blend (PB) comprises or consists of:
between 45.0 wt % and 65.0 wt % of at least one PEEK;
at least one amorphous thermoplastic polymer (ATP) (i) having a glass transition temperature Tg of at least 180° C. and (ii) selected in the group consisting of PPSU and combinations of PPSU and PES;
the total proportion of PEEK(s) and ATP(s) being between 85.0 wt % and 96.0 wt %;
between 1.0 wt % and 15.0 wt % of a least one inorganic filler selected in the group consisting of talc, boron nitride, mica, graphite, graphene and combination of two or more of said inorganic fillers;
optionally up to 14.0 wt % of at least one plastic additive, notably selected in the group consisting of colorants (e.g. dyes and/or pigments), impact modifiers, ultraviolet light stabilizer, heat stabilizers, antioxidants, internal lubricants and/or external lubricants, flame retardants, anti-static agents, anti-blocking agents and combinations thereof; and exhibits a heat of fusion (Hₘ) of at least 20.0 J/g.

According to the embodiment (E), the polymeric blend (PB) may be based on the combination of PEEK/PPSU. The polymeric blend (PB) thus accordingly comprises or consists of:
between 45.0 wt % and 65.0 wt % of at least one PEEK;
at least one amorphous PPSU having a glass transition temperature Tg of at least 180° C.;
the total proportion of PEEK(s) and PPSU(s) being between 85.0 wt % and 96.0 wt %;
between 1.0 wt % and 15.0 wt % of a least one inorganic filler selected in the group consisting of talc, boron nitride, mica, graphite, graphene and combination of two or more of said inorganic fillers;
optionally up to 14.0 wt % of at least one plastic additive, notably selected in the group consisting of colorants (e.g. dyes and/or pigments), impact modifiers, ultraviolet light stabilizer, heat stabilizers, antioxidants, internal lubricants and/or external lubricants, flame retardants, anti-static agents, anti-blocking agents and combinations thereof; and exhibits a heat of fusion (Hₘ) of at least 20.0 J/g.

The polymeric blend (PB) may comprise one or more than one PEEK and/or one PPSU or more than one PPSU.

According to embodiment (E), the polymeric blend (PB) may be based on the combination of PEEK/PPSU+PES. The polymeric blend (PB) thus accordingly comprises or consists of:
between 45.0 wt % and 65.0 wt % of at least one PEEK;
at least one amorphous PPSU having a glass transition temperature Tg of at least 180° C. and at least one amorphous PES having a glass transition temperature Tg of at least 180° C.;
the total proportion of PEEK(s), PES(s) and PPSU(s) being between 85.0 wt % and 96.0 wt %;
between 1.0 wt % and 15.0 wt % of a least one inorganic filler selected in the group consisting of talc, boron nitride, mica, graphite, graphene and combination of two or more of said inorganic fillers;
optionally up to 14.0 wt % of at least one plastic additive, notably selected in the group consisting of colorants (e.g. dyes and/or pigments), impact modifiers, ultraviolet light stabilizer, heat stabilizers, antioxidants, internal lubricants and/or external lubricants, flame retardants, anti-static agents, anti-blocking agents and combinations thereof; and exhibits a heat of fusion (Hₘ) of at least 20.0 J/g.

The proportions of the components of the polymeric blend (PB) being provided above apply equally to the combinations PEEK/PPSU or PEEK/PPSU+PES that are disclosed herein.

Moreover, for the polymeric blends (PB) associating PEEK, PPSU and PES, the proportion of PPSU is preferably lower than 10.0 wt %. This proportion may more particularly be between 1.0 wt % and 10.0 wt %.

The polymeric blend (PB) preferably does not comprise any polymer other than the PAEK(s), the ATP(s) and the polymer additive(s) (if any) that are based on a polymer (e.g. impact modifiers).

The polymeric blend (PB) also preferably does not comprise continuous fibers such as continuous carbon fibers or continuous glass fibers.

The polymeric blend (PB) is prepared by mixing the components of the blend, the polymers (notably PAEKs and ATPs) being in the molten form. The mixing can be performed in a mixing apparatus selected in the group consisting of kneaders, banbury mixers and extruders.

The polymeric blend (PB) is typically prepared by mixing the components of the composition in an extruder (e.g. single-screw or twin-screw extruder). The polymeric blend (PB) may be prepared according to the conditions provided in the experimental section.

The components of the polymeric blend (PB) are blended all together. They are preferably mixed so as to obtain an homogenous blend.

The polymeric blend (PB) of the invention exhibits a heat of fusion (Hₘ) of at least 20.0 J/g. This ensures that the polymeric blend (PB) exhibits sufficient chemical and mechanical resistance. Hₘ is preferably at least 40.0 J/g. Hₘ is generally between 20.0 J/g and 60.0 J/g.

The thermal properties of a polymer or of a polymer composition are measured by DSC according to ASTM D3418-03, notably according to the method provided in the Experimental Section.

### About the PAEK

The PAEK present in the polymer blend (PB) is a crystalline or semi-crystalline polymer that imparts the crystallinity to the polymeric blend (PB).

Polymeric blend (PB) may comprise only one PAEK. Polymeric blend (PB) may also comprise more than one PAEK. In that case, each PAEK may be characterized by distinct recurring units and/or distinct weight average molecular weights (M_{w}). For the avoidance of doubt, it is highlighted that in that case, the proportions given above correspond to the total proportion of PAEKs.

A “poly(aryl ether ketone) (PAEK)” denotes a polymer comprising more than 50.0 mol % of recurring units (R_{PAEK}) selected in the group consisting of units of formulae (J-A) to (J-Q) below:

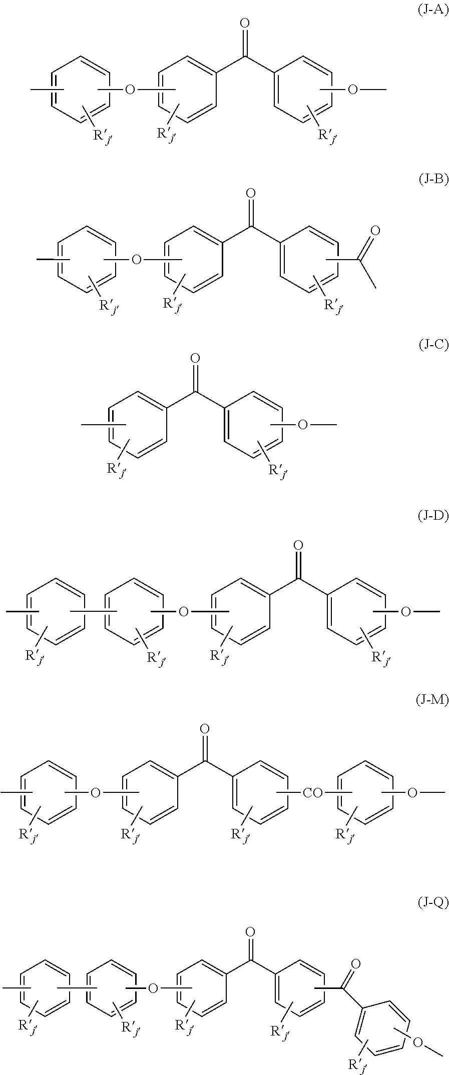

where the recurring units (R_{PAEK}) are linked to one another by —O— or —C(═O)— bonds and where each R′ of R′_{j′}, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium; and j′ is zero or an integer ranging from to 4.

According to a preferred embodiment of the present disclosure, j′ is zero.

More particularly, the PAEK present in the polymer blend (PB) is selected from the group consisting of PEEK, PEEK-PEDEK, PEKK, PEK, PEEKK, PEKEKK and combinations of two or more of said polymers. According to a preferred embodiment, the PAEK is selected from the group of PEEK, PEEK-PEDEK, PEKK and combinations thereof.

According to another preferred embodiment, the PAEK present in the polymer blend (PB) is PEEK.

### PEEK

More particularly, notably for embodiment (E), the PAEK is a poly(ether ether ketone) (PEEK). As used herein, a “poly(ether ether ketone) (PEEK)” denotes a polymer of which more than 90.0 mol % of the recurring units are recurring units of formula (J′-A):

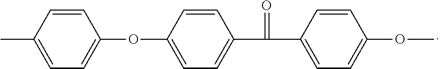

All details and embodiments relating to PEEK given below are applicable to any part of the present disclosure.

Preferably at least 95.0 mol %, preferably at least 99.0 mol % and most preferably all of recurring units of the PEEK are recurring units (J′-A).

The melt viscosity of the PEEK as measured according to ASTM D3835 at a temperature of 400° C. and a shear rate of 1000 l/s is preferably between 50 and 500 Pa s, more preferably between 100 and 350 Pa s.

### PEEK-PEDEK

As used herein, a PEEK-PEDEK denotes a polymer of which more than 90.0 mol % of the recurring units are recurring units of formula (J′-A) and (J′-D):

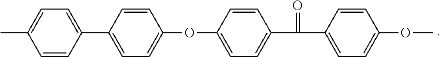

All details and embodiments relating to PEEK-PEDEK given below are applicable to any part of the present disclosure.

The moral ratio (J′-A)/(J′-D) may be between 95/5 and 5/95, preferably between 95/5 and 60/40.

Preferably at least 95.0 mol %, preferably at least 99.0 mol % and most preferably all of recurring units of the PEEK-PEDEK are recurring units (J′-A) and (J′-D).

### PEKK

More particularly, the PAEK is a poly(ether ketone ketone) (PEKK). As used herein, a “poly(ether ketone ketone) (PEKK)” denotes a polymer of which more than 90.0 mol % of the recurring units are a combination of recurring units of formula (J′-B) and formula (J″-B):

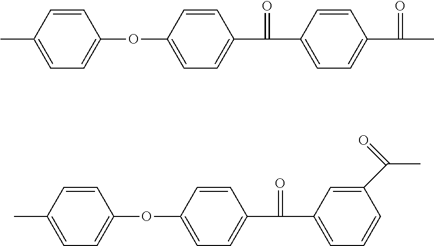

All details and embodiments relating to PEKK given below are applicable to any part of the present disclosure.

Preferably at least 95.0 mol %, preferably at least 99.0 mol and most preferably all of recurring units of the PEKK are a combination of recurring units (J′-B) and (J″-B).

### PEK

More particularly, the PAEK is a poly(ether ketone) (PEK). As used herein, a “poly(ether ketone) (PEK)” denotes a polymer of which more than 90.0 mol % of the recurring units are recurring units of formula (J′-C)

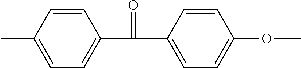

All details and embodiments relating to PEKgiven below are applicable to any part of the present disclosure.

Preferably at least 95.0 mol %, preferably at least 95.0 mol % and most preferably all of recurring units of the PEK are recurring units (J′-C).

### PEEKK

More particularly, the PAEK is a poly(ether ether ketone ketone) (PEEKK). As used herein, a “poly(ether ether ketone ketone) (PEEKK)” denotes a polymer of which more than 90.0 mol % of the recurring units are recurring units of formula (J′-M)

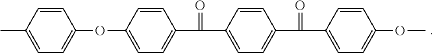

All details and embodiments relating to PEEKK given below are applicable to any part of the present disclosure.

Preferably at least 95.0 mol %, preferably at least 99.0 mol % and most preferably all of recurring units of the PEEKK are recurring units (J′-M).

### PEKEKK

More particularly, the PAEK is a PEKEKK polymer. As used herein, a “PEKEKK” denotes a polymer of which more than 90.0 mol % of the recurring units are recurring units of formula (J′-Q):

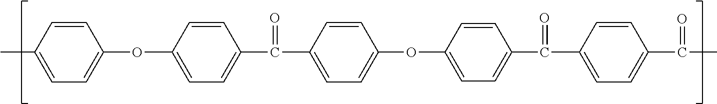

All details and embodiments relating to PEKEKK given below are applicable to any part of the present disclosure.

Preferably at least 95.0 mol %, preferably at least 99.0 mol and most preferably all of recurring units are recurring units (J′-Q).

### Preparation of the PAEKs

The PAEKs disclosed above are prepared by polycondensation techniques well known in the art, notably a nucleophilic route or an electrophilic one. More precisely, the PAEKs may be prepared by a nucleophilic aromatic substitution in which a diaryl ether linkage is obtained. The polycondensation is generally conducted in a solvent, such as a diphenyl sulfone, at 300° C. or more with the aid of a base such as K₂CO₃. More specifically, the PAEK may be obtained by polycondensation of a mixture of at least one aromatic compound bearing two hydroxyl groups and at least aromatic compound bearing two halogens, e.g. fluorine. For instance, PEEK is generally prepared by reacting hydroquinone with 4,4′-difluorobenzophenone in diphenylsulfone in the presence of at least one alkali-metal carbonate under an inert atmosphere at high temperatures, e.g. >300° C. Details about the polycondensation involving the nucleophilic substitution may be found in e.g. U.S. Pat. No. 4,176,222. More precisely, the PAEKs may be prepared by a Friedel-Crafts electrophilic substitution in which a diaryl ketone linkage is obtained. The polycondensation is generally conducted in a solvent at temperatures below 150° C. with the aid of a Lewis acid such as AlCl₃. Details about the polycondensation involving the Friedel-Crafts electrophilic substitution may be found in e.g. U.S. Pat. Nos. 4,841,013, 4,816,556, WO 2011/004164 and WO 2014/013202.

### About the ATP

The ATP present in the polymer blend (PB) is selected in the group consisting of polyphenylsulfone (PPSU), polyethersulfone (PES), polysulfone (PSU), polyetherimide (PE) and combination of two or more of said polymers.

The ATP present in the polymer blend (PB) may more particularly be selected in the group consisting of polyphenylsulfone (PPSU), polyethersulfone (PES) and a combination of a polyphenylsulfone (PPSU) and a polyethersulfone (PES).

The ATP present in the polymer blend (PB) may more particularly be PPSU or the combination PPSU+PES.

Each of the polymers ATP is amorphous and exhibits a Tg >180° C. The polymeric blend (PB) may also be based on the combination of two or more of said polymers. In this case, the blend of two or more of said polymers is also amorphous and also exhibits at least one Tg >180° C.

### PPSU

A polyphenylsulfone (PPSU) denotes a polymer comprising at least 90.0 mol. % of recurring units (R_{PPSU}) of formula (L″):

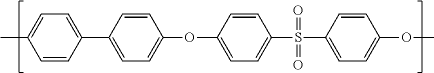

All details and embodiments relating to PPSU given below are applicable to any part of the present disclosure.

The proportion of recurring units (R_{PPSU}) is preferably at least 95.0 mol, preferably at least 99.0 mol %. According to a preferred embodiment, the recurring units of the PPSU consist of recurring units of formula (L″).

The melt flow rate (MFR) of the PPSU is preferably between 20.0 and 50.0 g/10 min, preferably between 25.0 g/10 min and 40.0 g/10 min, as measured according to ASTM D1238 at 365° C. with a 5.0 kg weight.

### PES

A polyethersulfone (PES) denotes a polymer comprising at least 90.0 mol. % of recurring units (R_{PES}) of formula (O″):

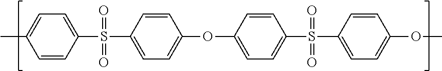

All details and embodiments relating to PES given below are applicable to any part of the present disclosure.

The proportion of recurring units (R_{PES}) is preferably at least 95.0 mol, preferably at least 99.0 mol %. According to a preferred embodiment, the recurring units of the PES consist of recurring units of formula (O″).

The melt flow rate (MFR) of the PES is preferably between 20.0 and 120.0 g/10 min, preferably between 50.0 g/10 min and 90.0 g/10 min, as measured according to ASTM D1238 at 380° C. with a 2.16 kg weight.

### PSU

A polysulfone (PSU) denotes a polymer comprising at least 90.0 mol. % of recurring units (R_{PSU}) of formula (N″):

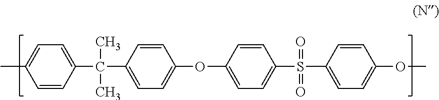

All details and embodiments relating to PSU given below are applicable to any part of the present disclosure.

The proportion of recurring units (R_{PSU}) is preferably at least 95.0 mol, preferably at least 99.0 mol %. According to a preferred embodiment, the recurring units of the PES consist of recurring units of formula (N″).

The melt flow rate (MFR) of the PSU is preferably between 5.0 and 25.0 g/10 min, preferably between 10.0 g/10 min and 20.0 g/10 min, as measured according to ASTM D1238 at 343° C. with a 2.16 kg weight.

### Polyetherimide (PEI)

A polyetherimide denotes a polymer comprising at least 90.0 mol. % of recurring units (R_{PEI}) of formula (Q″):

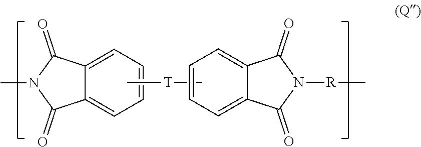

where T is —O— or a group —O—Z—O— where Z is

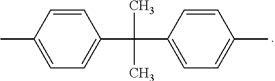

and R is a divalent radical of a diamine of formula ₂NH—R—NH₂ selected in the group consisting of m-phenylenediamine, p-phenylenediamine, 2,2-bis(p-aminophenyl)propane, 4,4′-diaminodiphenyl-methane, 4,4′-diaminodiphenyl sulfide, 4,4′-diamino diphenyl sulfone, 4,4′-diaminodiphenyl ether, 1,5-diaminonaphthalene, 3,3′-dimethylbenzidine, 3,3′-dimethoxybenzidine, and mixtures thereof.

The diamine may more particularly be m-phenylenediamine, p-phenylenediamine or a mixture thereof.

### Inorganic Filler

The inorganic filler may more particularly be selected in the group consisting of talc, boron nitride, graphene and combinations of two or more of said fillers.

Talc is typically described as a hydrous magnesium silicate mineral with a chemical composition Mg₃Si₄O₁₀(OH)₂. Although the composition of talc usually stays close to this generalized formula, some substitution may occur. Small amounts of Al or Ti can substitute Si and small amounts of Fe, Mn, Al and/or Ca can substitute for Mg.

The graphene nanoplatelets of graphene typically include an average of between about 1 to about 40 layers. The number of layers can be measured by Raman spectroscopy.

Derivatives of graphene can also be used as inorganic fillers in the polymeric blend (PB). A derivative of graphene can be selected in the group consisting of graphene oxide (GO), partially reduced graphene oxide and functionalized graphene.

The inorganic filler present in the polymeric blend (PB) may be more particularly talc or boron nitride. The inorganic filler present in the polymer blend is preferably talc.

The inorganic filler present in the polymeric blend (PB) may more particularly be a platy inorganic filler.

The inorganic filler present in the polymeric blend (PB) may more particularly be characterized by two aspect ratios AR1 and AR2 (see e.g. Applied Clay Science 2011, 53(4), 544-582). AR1 is the ratio between the major axis a and the minor axis b of an ellipse best fitting a particle of the filler and AR2 is the ratio between the major axis a and the thickness c of the the particle, with major axis a>minor axis b>thickness c. AR1 and AR2 are determined by Scanning Electron Microscopy (SEM) on a large number of particles (e.g. at least 200). The arithmetic average AR1 is between 1 and 4 and the arithmetic average AR2 is >10.0.

Preferably, the inorganic filler present in the polymeric blend (PB) exhibits a D50 lower than 100.0 microns, D50 being the median of a distribution of size in volume obtained by laser diffraction measurement. Generally, D50 is at least 0.5 microns.

According to an embodiment, D50 is lower than 50.0 microns.

The inorganic filler(s) present in the polymeric blend (PB) are dispersed in the polymeric blend (PB).

### Plastic Additive(s)

Polymeric blend (PB) may also comprise at least one plastic additive that is different from the inorganic filler.

The plastic additive may be selected in the group consisting of colorants (e.g. dyes and/or pigments), impact modifiers, ultraviolet light stabilizer, heat stabilizers, antioxidants, internal lubricants and/or external lubricants, flame retardants, anti-static agents, anti-blocking agents and combinations thereof.

Impact modifiers are plastic additives that improve toughness of a polymer or a polymer composition. They generally exhibit an elastomeric and rubbery nature so as to absorb or dissipate the energy of an impact. The polymeric blend (PB) may comprise at least one impact modifier, notably comprising a polymeric component selected in the group of ethylene-propylene copolymers (EPR), ethylene/1-butene copolymers, ethylene/1-hexene copolymers, ethylene/propylene/1-hexene terpolymers, ethylene/propylene/1-hexene terpolymers, ethylene/propylene/1,4-hexadiene terpolymer, ethylene/propylene/ethylidene norbornene terpolymers, butadiene rubbers, butyl rubbers and styrene/butadiene rubbers. The polymeric component may be functionalized by grafting one or more unsaturated compound bearing a polar group, such as maleic anhydride.

The polymeric blend (PB) usually comprises at least one colorant to impart a specific color to the polymer part of the body panel.

The total proportion of the plastic additive(s) in the polymeric blend (PB) is generally lower than 14.0 wt % or lower than 10.0 wt %.

### Physico-Chemical Properties of the Polymeric Blend (PB)

The polymeric blend (PB) may also be defined by one or more physico-chemical properties as defined herein. Indeed, the polymeric blend (PB) exhibits at least one of the following properties:
(a) a coefficient of linear thermal expansion (CLTE) measured between 0° C. and 100° C. according to ASTM E831 which is less than or equal to 57×10⁻⁶° C.⁻¹, preferably less than or equal to 55×10⁻⁶° C.⁻¹, preferably less than or equal to 50×10⁻⁶° C.⁻¹, preferably less than or equal to 45×10⁻⁶° C.⁻¹, more preferably less than or equal to 40×10⁻⁶° C.⁻¹;
(b) a puncture energy absorbed calculated at a point equal to 50% drop from the maximum load and measured at −15° C. on a plaque measuring 10.16 cm×10.16 cm×0.32 cm (4 in×4 in×0.125 in) per ASTM D3763 greater than or equal to 30.0 J, preferably greater than or equal to 50.0 J, preferably greater than or equal to 55.0 J, preferably greater than or equal to 60.0 J;
(c) a heat deflection temperature at 1.82 MPa measured according to ASTM D648 of at least 170° C., preferably at least 180° C. and most preferably at least 190° C.;
(d) a tensile modulus of at least 3000 MPa, preferably at least 3500 MPa, preferably at least 4000 MPa, measured according to ISO 527.

According to an embodiment of the present disclosure, the polymeric blend (PB) exhibits at least one of the following properties:
(a) a coefficient of linear thermal expansion (CLTE) measured between 0° C. and 100° C. according to ASTM E831 which is less than or equal to 50×10⁻⁶° C.⁻¹, preferably less than or equal to 45×10⁻⁶° C.⁻¹, more preferably less than or equal to 40×10⁻⁶° C.⁻¹;
(b) a puncture energy absorbed calculated at a point equal to 50% drop from the maximum load and measured at −15° C. on a plaque measuring 10.16 cm×10.16 cm×0.32 cm (4 in×4 in×0.125 in) per ASTM D3763 greater than or equal to 60.0 J;
(c) a heat deflection temperature at 1.82 MPa measured according to ASTM D648 of at least 190° C.;
(d) a tensile modulus of at least 3500 MPa as measured according to ISO 527.

The tensile modulus is typically at most 4500 MPa as measured according to ISO 527.

The puncture energy is typically at most 90.0 J.

The heat deflection temperature is typically at most 210° C.

According to an embodiment of the present disclosure, the polymeric blend (PB) exhibits all four properties (a)-(d) listed herein.

These properties are measured according to the methods disclosed in the Experimental Section.

Moreover, the polymeric blend (PB) preferably exhibits a low viscosity so that the blend can be injection moulded. Thus, the polymeric blend (PB) preferably exhibits a melt viscosity measured at 5000 s⁻¹ and at 400° C. lower than or equal to 150 Pa s. The melt viscosity disclosed herein is measured with a capillary rheometer according to ASTM D3835. For the measurement of the viscosity, a tungsten carbide (capillary diameter: 0.5 mm; capillary length: 8 mm) is generally used.

### EXPERIMENTAL SECTION

The invention is also illustrated by the following examples.

### Starting Materials Used

The polymers used in the examples were:
PAEK: polyetheretherketone (PEEK)—grade KetaSpire KT-880 NT available from Solvay Specialty Polymers. This grade has a melt viscosity in the range 120-180 Pa-s as measured per ASTM D3835 at 400° C. and a shear rate of 1000 l/s.
Polyphenylsulfones (PPSU): grade R-5900 NT available from Solvay Specialty Polymers. This grade exhibits a MFR of 26-36 g/10 min as measured according to ASTM D1238 using a temperature of 365° C. and 5.0 kg weight. Grade R-5100NT available from Solvay Specialty Polymers. This grade exhibits a MFR of 13-20 g/10 min as measured according to ASTM D1238 using a temperature of 365° C. and 5.0 kg weight. has a MFR of 13-20
Polyethersulfone (PES): grade 3600 NT available from Solvay Specialty Polymers

The minerals and other additives used were the following:
Talc—grade Mistron® from Imerys Performance Additives; D50 of about 2 m.
Boron nitride—grade Boronid® S1-SF available from 3M Corporation.
Zinc oxide—grade Activ® R-609, which was procured from Lanxess Corporation Zinc stearate—grade 2222 from Baerlocher Corporation.
Graphene—GrapheneBlack 3× from NanoXplore—used as a masterbatch Ketaspire KT-880/graphene (30 wt %). This graphene exhibits the following properties: C>91 at %; O<7 at %; D50=38 μm; number of layers=6-10; bulk density=0.18 g/cm³ (see technical data sheet https://www.nanoxplore.ca/wp-content/uploads/2018/11/Nanoxplore-GrapheneBlack-3×-Datasheet_180923.pdf).

Preparation of the polymeric blends: all blends were prepared by first tumble blending pellets or powders of the components of the polymeric blend to be blended at the desired compositional ratios for about 20 minutes, followed by melt compounding using a 26 mm diameter Coperion ZSK-26 co-rotating partially intermeshing twin screw extruder having an L/D ratio of 48:1. The extruder had 12 barrel sections with barrel sections 2 through 11 being heated with set point temperature of 350° C. The die section was also set to a temperature of 350° C.

The ingredient mixture pre-blend was fed at barrel section 1 using a gravimetric feeder at nominal throughput rates ranging from 17.5 to 28 lb/hr. The extruder was operated at a screw speed of about 200 rpm and vacuum venting was applied at barrel section 10 during compounding to strip off moisture and any possible residual volatiles from the compound. A single-hole die was used for all the blends and the molten polymer strand exiting the die was cooled in a water trough and then cut in a pelletizer to form pellets approximately 3.0 mm in length by 2.7 mm in diameter.

### Injection Molding

Injection molding was used to produce the test specimens for the measurement of the mechanical properties and heat deflection temperature. 25 tensile and 25 flexural specimens were prepared from each composition. The tensile test specimens were ISO Type I. The mechanical test specimens were injection molded using the following approximate set point conditions which are in harmony with injection molding guidelines recommended by the suppliers for the different polymers:
Rear barrel section: 710° F. (376° C.)
Middle barrel section: 710° F. (376° C.)
Front barrel section: 710° F. (376° C.)
Nozzle: 710° F. (376° C.)
Mold: 410° F. (210° C.)

### Testing

The following ISO and ASTM test methods were employed in evaluating all compositions disclosed in the present disclosure:
ISO 527: tensile properties, measured at a test speed of 50 mm/min;
ASTM D648: heat deflection temperature at 264 psi (1.82 MPa), measured on specimens annealed for 2 hours at 200° C.;
ASTM D3763: instrumented Multiaxial Impact, measured on plaques measuring 10.16 cm×10.16 cm×0.32 cm (or 4 in×4 in×0.125 in). Temperature of testing: −15° C.; test speed: 200 m/min.

All mechanical tests except heat deflection temperature were carried out on as injection molded test parts.

More details about the puncture energy are given in ASTM D3763-23.

For convenience, unless otherwise expressly indicated, the following correspondance can be used: 1 inch=2.54 cm. See also: “NIST Special Publication 1038—The International System of Units (SI)—Conversion Factors for General Use”, May 2006.

Thermal properties (in particular Hm) of the polymers and polymeric blends (PB) are measured by DSC according to ASTM D3418-03. A heating and cooling rate of 20° C./min are employed and Hm was measured using the second heat scan.

The results are detailed in Table I below. As is visible, it is possible to obtain a polymeric blend (PB) having a balance of properties, notably a low CLTE and a high puncture energy at low temperature.

TABLE I

| | | | | | | | | | |
|---|---|---|---|---|---|---|---|---|---|
| Ex. | CE1 | E2 | E3 | E4 | E5 | E6 | E7 | E8 | E9 |

Components of the polymeric blend (PB)

| | | | | | | | | | |
|---|---|---|---|---|---|---|---|---|---|
| PAEK | PEEK | PEEK KT- | PEEK KT- | PEEK KT- | PEEK KT- | PEEK | PEEK KT- | PEEK KT- | PEEK KT- |
| | KT-880P | 880P | 880P | 880P | 880P | KT-880P | 880P | 880P | 880P |
| | 53.5% | 47.1% | 52.6% | 48.0% | 50.4% | 49.8% | 54.1% | 56.1% | 53.9% |
| ATP | PES | PES | PES | PES | PES | PES | PES | PPSU | PPSU |
| | Veradel | Veradel | Veradel | Veradel | Veradel | Veradel | Veradel | Radel R- | Radel R- |
| | 3600 | 3600 | 3600 | 3600 | 3600 | 3600 | 3600 | 5900 NT | 5100 NT |
| | 39.2% + | 33.1% + | 34.7% + | 37.6% + | 37.4% + | 36.8% + | 35.9% + | 37.5% | 40.9% |
| | PPSU | PPSU | PPSU | PPSU | PPSU | PPSU | PPSU | | |
| | Radel R- | Radel R- | Radel R- | Radel R- | Radel R- | Radel R- | Radel R- | | |
| | 5900 NT | 5900 NT | 5900 NT | 5900 NT | 5900 NT | 5900 NT | 5900 NT | | |
| | 7.1% | 6.8% | 7.5% | 8.0% | 7.0% | 6.8% | 7.8% | | |
| Inorganic | / | Talc | Graphene | BaSO₄ | BN 5% | Talc | Graphene | Talc | BN 5% |
| filler(s) | | 12.8% | 5% | 6.2% | | 6.4% | 2% | 6.2% | |

Properties of the polymeric blend (PB)

| | | | | | | | | | |
|---|---|---|---|---|---|---|---|---|---|
| Hm (J/g) | / | / | 39.2 | 24.0 | 51.6 | 42.2 | 43.5 | 43.8 | 50.7 |
| Total energy | 76.8 | 14.8 | 5.7 | 57.2 | 81.5 | 68.8 | 39.0 | 66.8 | 67 |
| of puncture | | | | | | | | | |
| (J) | | | | | | | | | |
| CLTE (°C⁻¹) | 58.7 | 36.4 | / | 56.0 | 41.9 | 43.9 | 48.0 | 43.0 | 39 |
| Tensile | 3280 | 4970 | / | 3330 | 4120 | 4080 | 3770 | 3830 | 3730 |
| modulus | | | | | | | | | |
| (MPa) | | | | | | | | | |
| HDT at 1.82 | 208 | / | / | / | / | / | 204 | 192 | 192 |
| MPa (°C) | | | | | | | | | |

All polymeric blends (PB) of this Table I also comprise plastic additives: 0.1% ZnO and Hostanox PEPQ 0.1%

1. An automotive body part comprising a polymeric part made of or comprising a polymeric blend (PB) which comprises:
between 45.0 wt % and 65.0 wt % of at least one polyaryletherketone (PAEK);
at least one amorphous thermoplastic polymer (ATP) (i) having a glass transition temperature Tg of at least 180° C. and (ii) selected from the group consisting of polyphenylsulfone (PPSU), polyethersulfone (PES), polysulfone (PSU), polyetherimide (PEI), and combinations of two or more of said polymers;
the total proportion of PAEK(s) and ATP(s) being between 85.0 wt % and 96.0 wt %;
between 1.0 wt % and 15.0 wt % of at least one inorganic filler selected from the group consisting of talc, boron nitride, mica, graphite, graphene, and combinations of two or more of said inorganic fillers;
optionally up to 14.0 wt % of at least one plastic additive;
these proportions being given in wt % relative to the total weight of the polymeric blend (PB); and which exhibits a heat of fusion (Hₘ) of at least 20.0 J/g, Tg and Hₘ being measured by DSC according to ASTM D3418-03.

2. The automotive body part according to claim 1, wherein the amorphous thermoplastic polymer (ATP) is selected from the group consisting of polyphenylsulfone (PPSU), polyethersulfone (PES), polysulfone (PSU), and combinations of two or more of said polymers.

3. The automotive body part according to claim 1, wherein the polymeric blend (PB) exhibits a coefficient of linear thermal expansion (CLTE) measured between 0° C. and 100° C. according to ASTM E831 which is less than or equal to 57×10⁻⁶° C.⁻¹.

4. (canceled)

5. (canceled)

6. (canceled)

7. (canceled)

8. (canceled)

9. The automotive body part according to claim 1, wherein the proportion of PAEK(s) is between 45.0 wt % and 60.0 wt %.

10. The automotive body part according to claim 1, wherein the total proportion of PAEK(s) and ATP(s) is at least 88.0 wt %.

11. (canceled)

12. The automotive body part according to claim 1, wherein the PAEK is selected from the group consisting of: PEEK, PEEK-PEDEK, PEKK, PEK, PEEKK, PEKEKK, and combinations of two or more of said polymers.

13. (canceled)

14. (canceled)

15. (canceled)

16. (canceled)

17. (canceled)

18. (canceled)

19. (canceled)

20. (canceled)

21. The automotive body part according to claim 1, wherein the polymeric blend (PB) comprises PEEK(s)+PPSU(s) or PEEK(s)+PPSU(s)+PES(s).

22. The automotive body part according to claim 1, wherein the polymeric blend (PB) comprises:
between 45.0 wt % and 65.0 wt % of at least one PEEK;
at least one amorphous PPSU having a glass transition temperature Tg of at least 180° C.;
the total proportion of PEEK(s) and PPSU(s) being between 85.0 wt % and 96.0 wt %;
between 1.0 wt % and 15.0 wt % of at least one inorganic filler selected from the group consisting of talc, boron nitride, mica, graphite, graphene, and combination of two or more of said inorganic fillers;
optionally up to 14.0 wt % of at least one plastic additive selected from the group consisting of colorants, impact modifiers, ultraviolet light stabilizer, heat stabilizers, antioxidants, internal lubricants and/or external lubricants, flame retardants, anti-static agents, anti-blocking agents, and combinations thereof.

23. The automotive body part according to claim 1, wherein the polymeric blend (PB) comprises:
between 45.0 wt % and 65.0 wt % of at least one PEEK;
at least one amorphous PPSU having a glass transition temperature Tg of at least 180° C. and at least one amorphous PES having a glass transition temperature Tg of at least 180° C.;
the total proportion of PEEK(s), PES(s) and PPSU(s) being between 85.0 wt % and 96.0 wt %;
between 1.0 wt % and 15.0 wt % of at least one inorganic filler selected from the group consisting of talc, boron nitride, mica, graphite, graphene, and combination of two or more of said inorganic fillers;
optionally up to 14.0 wt % of at least one plastic additive selected from the group consisting of colorants, impact modifiers, ultraviolet light stabilizer, heat stabilizers, antioxidants, internal lubricants and/or external lubricants, flame retardants, anti-static agents, anti-blocking agents, and combinations thereof.

24. (canceled)

25. The automotive body part according to claim 1, wherein the inorganic filler is a platy inorganic filler.

26. (canceled)

27. (canceled)

28. The automotive body part according to claim 1, wherein the polymeric blend (PB) exhibits one or more of the following properties:
(a) a coefficient of linear thermal expansion (CLTE) measured between 0° C. and 100° C. according to ASTM E831 which is less than or equal to 50×10⁻⁶° C.⁻¹;
(b) a puncture energy absorbed calculated at a point equal to 50% drop from the maximum load and measured at −15° C. on a plaque measuring 10.16 cm×10.16 cm×0.32 cm (4 in×4 in×0.125 in) per ASTM D3763 greater than or equal to 60.0 J;
(c) a heat deflection temperature at 1.82 MPa measured according to ASTM D648 of at least 190° C.; and
(d) a tensile modulus of at least 3500 MPa as measured according to ISO 527.

29. The automotive body part according to claim 1 wherein a layer (L) is in contact with a surface of the polymeric part, layer (L) being constituted of layers (L1)/(L2), the layer (L1) being an adhesive layer and layer (L2) being a layer imparting a visual effect and/or protection.

30. (canceled)

31. (canceled)

32. The automotive body part according to claim 1, wherein the polymeric part is a tri-dimensional structure having a length, a width and thickness, wherein both length L and width W are significantly larger than the thickness T, L/T and W/T being greater than or equal to 100.

33. The automotive body part according to claim 1, wherein the polymeric part is a panel.

34. The automotive body part according to claim 1, wherein the automotive body part is selected from the group consisting of: roof panels, hood panels, deck panels, rear fender panels, front fender panels, quarter panels, trunk lids, rear hatch panels, floor panels, and door panels.

35. (canceled)

36. (canceled)

37. (canceled)

38. (canceled)

39. (canceled)

40. (canceled)

41. A method of preparation of the polymeric part of the automotive body part according to claim 1 comprising the step of injection moulding the polymeric blend (PB).

42. (canceled)

43. The method according to claim 41, wherein the polymeric part is a tri-dimensional structure having a length, a width and thickness, wherein both length L and width W are significantly larger than the thickness T, L/T and W/T being greater than or equal to 100.

44. The method according to claim 41, wherein the polymeric part is a panel.

45. The method according to claim 41, wherein the automotive body part is selected in the group consisting of: roof panels, hood panels, deck panels, rear fender panels, front fender panels, quarter panels, trunk lids, rear hatch panels, floor panels, and door panels.
